(19) United States
(12) Patent Application Publication
(10) Pub. No.: US 2024/0000664 A1
(43) Pub. Date: Jan. 4, 2024

(54) Medicine bottle with telescopic spoon

(71) Applicant: Huapeng Lin, Guangzhou (CN)

(72) Inventor: Huapeng Lin, Guangzhou (CN)

(21) Appl. No.: 18/226,610

(22) Filed: Jul. 26, 2023

(30) Foreign Application Priority Data
Jan. 7, 2023 (CN) 202320038380.2

(51) Int. Cl. A61J 7/00; A61J 1/14

(52) U.S. Cl. CPC A61J 7/0023; A61J 1/1418; A61J 1/1462

(57) ABSTRACT

A medicine bottle includes a bottle body. A bottle cap is covered on the bottle body in a sealing manner. A fixed rod is inserted into the bottle cap. A telescopic rod is provided on the fixed rod. A telescopic spoon is provided on the telescopic rod. The telescopic spoon is located in the bottle body. The bottle body and the bottle cap are connected in a sealing manner.

### BACKGROUND OF THE INVENTION

### 1. Field of the Invention

The invention relates to medical containers and more particularly to a medicine bottle with a telescopic spoon.

### 2. Description of Related Art

A conventional medicine bottle has a relatively simple structure, consisting of a bottle body and a bottle cap. When in use, the bottle cap is directly unscrewed to pour out a medicine in the bottle. Because it is difficult to control an amount of the medicine upon taking the medicine, a large amount of the medicine will often be poured out, pills are directly poured onto the hands upon taking the medicine, and the excess pills will be directly put into the bottle, which is not only unhygienic for the medicine, but also contaminates the medicine in the bottle.

In order to prevent drug contamination and improve medication hygiene, some users use a medicine spoon of a specific length to take the medicine. The medicine spoon is generally long and thus cannot be placed in the bottle, which brings a lot of inconvenience to the users. Moreover, the bottle cap and the bottle body have a poor seal, causing the medicine to get damp if the medicine is taken for multiple times.

Thus, the need for improvement still exists.

### SUMMARY OF THE INVENTION

A purpose of the invention is to provide a medicine bottle with a telescopic spoon, which cannot only prevent a medicine from being contaminated and getting damp, but also facilitates users to take the medicine.

In order to achieve the above purpose, the invention adopts a technical solution as follows:

A medicine bottle with a telescopic spoon includes a bottle body, an upper cover of which is provided with a bottle cap, where a fixed rod is inserted into a closed end of the bottle cap, the end, far away from the bottle cap, of the fixed rod is telescopically connected with a telescopic rod along its axial direction, a telescopic spoon is provided at an end of the telescopic rod, the telescopic spoon is located in the bottle body, and the bottle body and the bottle cap are connected through a sealing ring in a sealing manner.

As an improvement of the medicine bottle with the telescopic spoon of the invention, the sealing ring is sleeved outside the bottle cap, and exposed to the bottle cap and the bottle body.

As an improvement of the medicine bottle with the telescopic spoon of the invention, internal threads of the bottle body are screwed with external threads of the bottle cap, and the sealing ring is located above the external threads.

As an improvement of the medicine bottle with the telescoping spoon of the invention, a boss is protruded on a top of the bottle cap, and an annular hanging ring is connected on the boss.

As an improvement of the medicine bottle with the telescopic spoon of the invention, the boss is cylindrical, a through hole runs through the boss along its radial direction, and the hanging ring runs through the through hole.

As an improvement of the medicine bottle with the telescopic spoon of the invention, both the bottle cap and the bottle body are made of metal materials, and a bottom of the bottle body is convex and arranged in an arc shape.

As an improvement to the medicine bottle with the telescopic spoon of the invention, the telescopic rod is movably inserted into the fixed rod, and the fixed rod, the telescopic rod and the telescopic spoon are all made of metal materials.

The invention has the following advantages and benefits in comparison with the conventional art: the telescopic and length-adjustable telescopic scoop is provided on the bottle cap, so that medicine contamination can be prevented, it is convenient for users to take the medicine, and at the same time, the bottle body and the bottle cap are connected through a sealing ring in a sealing manner to prevent the medicine from getting damp.

The above and other objects, features and advantages of the invention will become apparent from the following detailed description taken with the accompanying drawings.

### BRIEF DESCRIPTION OF THE DRAWINGS

FIG. 1 is a perspective view of a medicine bottle of the invention;

FIG. 2 is an exploded view of the medicine bottle;

FIG. 3 is a longitudinal sectional view of the medicine bottle;

FIG. 4 is a front view of the telescopic scoop in a retracted state; and

FIG. 5 is a view similar to FIG. 4 showing the telescopic scoop in an extended state.

### DETAILED DESCRIPTION OF THE INVENTION

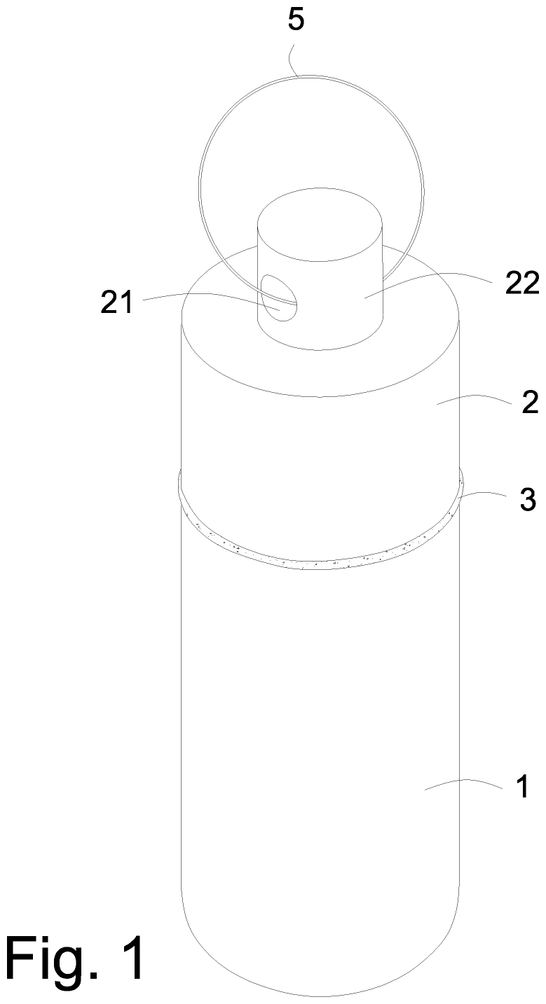

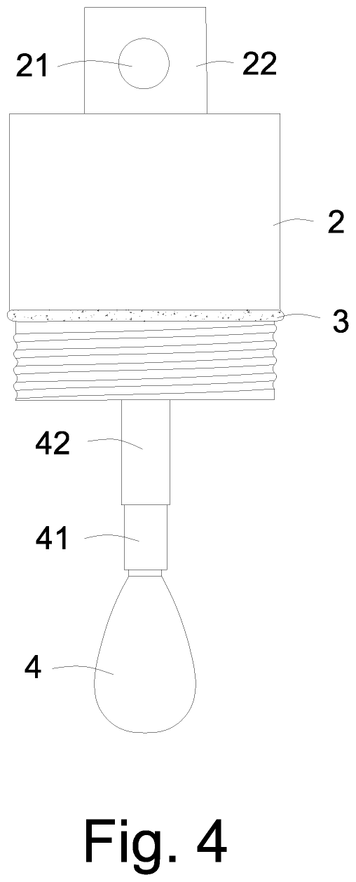

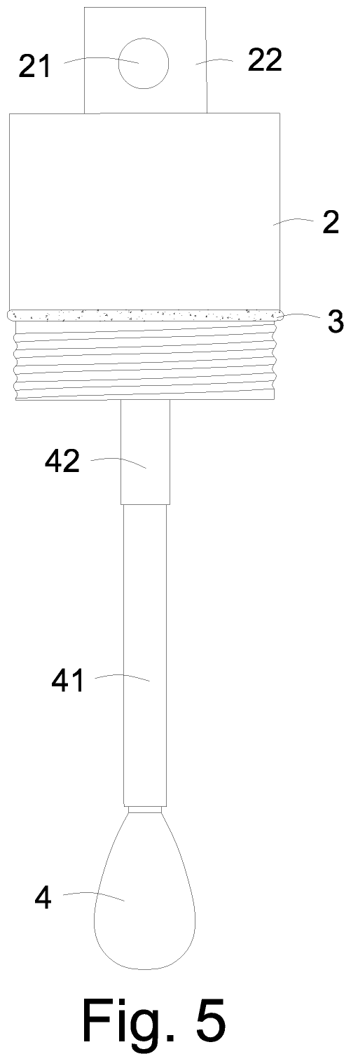

Referring to FIG. 1 to FIG. 5, a medicine bottle of the invention comprises a bottle body 1, a bottle cap 2 and a telescopic spoon 4, where the bottle cap 2 is covered on bottle body 1 in a sealing manner, a fixed rod 42 is inserted into a closed end of the bottle cap 2, the end, far away from the bottle cap 2, of the fixed rod 42 is telescopically connected with a telescopic rod 41 along its axial direction, the telescopic spoon 4 is provided at an end of the telescopic rod 41, the telescopic spoon 4 is located in the bottle body 1, and the bottle body 1 and the bottle cap 2 are connected through a sealing ring 3 in a sealing manner.

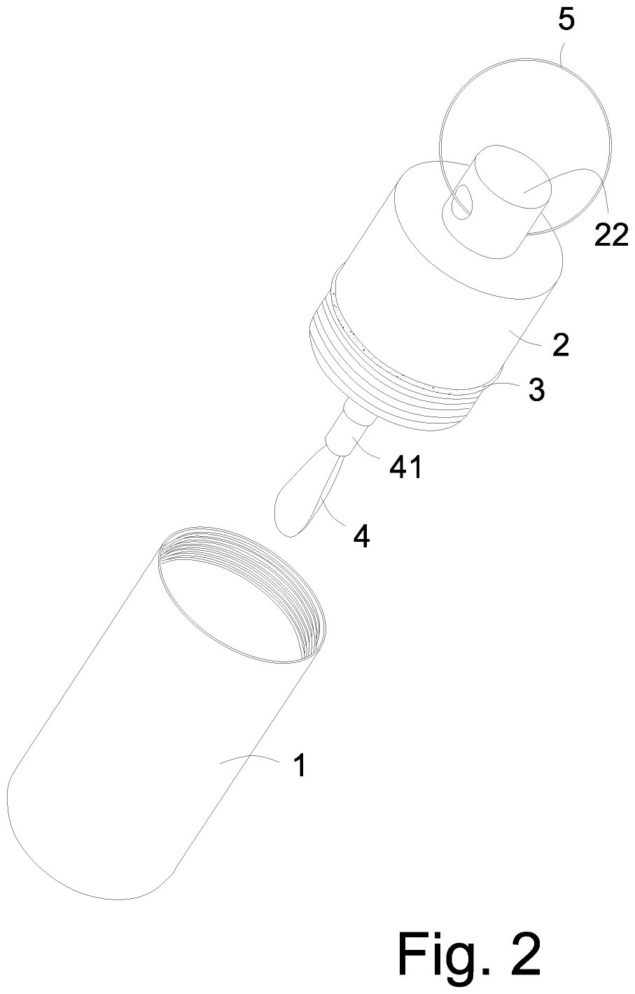

As shown in FIG. 2 specifically, the bottle body 1 is made of a metal material, an inner wall of the bottle body 1 is provided with internal threads, a bottom of the bottle body 1 is convex and arranged in an arc shape, and the bottle cap 2 is in the shape of a shell.

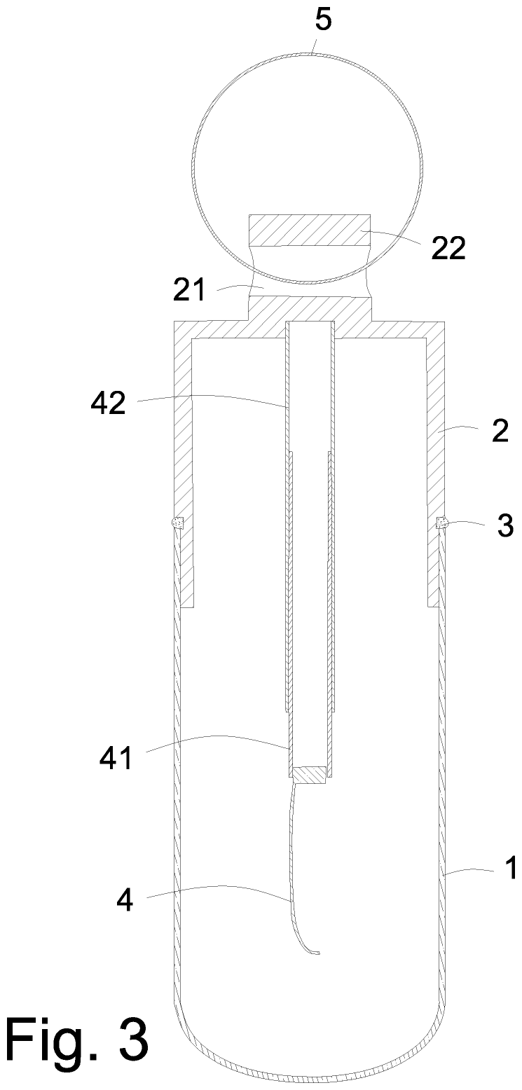

As shown in FIG. 2 and FIG. 3 specifically, the bottle cap 2 is made of a metal material, a top of the bottle cap 2 is protruded with a boss 22, the boss 22 is cylindrical, and an annular hanging ring 5 is connected on the boss 22. Specifically, a through hole 21 runs through the boss 22 along its radial direction, the hanging ring 5 runs through the through hole 21, an outer wall of the bottle cap 2 is provided with external threads, the internal threads of the bottle body 1 are screwed with the external threads of the bottle cap 2, and the sealing ring 3 is sleeved outside the bottle cap 2 and located above the external threads of the bottle cap 2. When the bottle cap 2 is covered on the bottle body 1 and screwed with the bottle body 1, the sealing ring 3 is exposed to the bottle cap 2 and bottle body 1.

As shown in FIG. 3 specifically, the fixed rod 42 is directly and fixedly inserted in the bottle cap 2, an upper end of the telescopic rod 41 is movably inserted into the fixed rod 42 from bottom to top, the top of the telescopic rod 41 is hooked inside the fixed rod 42, the telescopic spoon 4 is fixed at the bottom of the telescopic rod 41, and the fixed rod 42, the telescopic rod 41 and the telescopic spoon 4 are all made of metal materials. When the bottle cap 2 is screwed with the bottle body 1, both the telescopic rod 41 and the telescopic spoon 4 are located in the bottle body 1.

As shown in FIG. 1 to FIG. 3 specifically, a method for using the medicine bottle with the telescopic spoon of the invention is as follows:

A user fully fills the bottle body 1 with the medicine, covers the bottle cap 2, and hangs the hanging ring 5 on a keychain or bag, which is not only convenient to carry the medicine, but also can use the medicine bottle as a decorative part.

When needing to use the medicine in the medicine bottle, the user directly unscrews the bottle cap 2, manually pulls the telescopic rod 41 outward to make the part of the telescopic rod 41 extending beyond the fixed rod 42 become longer, holds the bottle cap 2, and uses the telescopic spoon 4 to take out the fixed-dose medicine in the bottle body 1.

After the use is finished, the telescopic rod 41 is manually pushed to make the part of the telescopic rod 41 that extends outside the fixed rod 42 retract into fixed rod 42, a combined length of the telescopic rod 41 and the fixed rod 42 becomes smaller, and the bottle cap 2 is covered.

According to the medicine bottle with the telescopic spoon of the invention, the telescopic and length-adjustable telescopic scoop 4 is provided on the bottle cap 2, so that medicine contamination can be prevented, and it is convenient for the user to take the medicine. Meanwhile, the bottle body 1 and the bottle cap 2 are connected through the sealing ring 3 in the sealing manner, so that the medicine will not get damp even with multiple pickups.

While the invention has been described in terms of preferred embodiments, those skilled in the art will recognize that the invention can be practiced with modifications within the spirit and scope of the appended claims.

What is claimed is:

1. A medicine bottle, comprising:
a bottle body, an upper cover of which is provided with a bottle cap,
wherein a fixed rod is inserted into a closed end of the bottle cap, an end, far away from the bottle cap, of the fixed rod is telescopically connected with a telescopic rod along its axial direction, a telescopic spoon is provided at an end of the telescopic rod, the telescopic spoon is located in the bottle body, the bottle body and the bottle cap are connected through a sealing ring in a sealing manner, a top of the bottle cap is protruded with a boss, and an annular hanging ring is connected on the boss.

2. The medicine bottle of claim 1, wherein the sealing ring is sleeved outside the bottle cap, and exposed to the bottle cap and the bottle body.

3. The medicine bottle of claim 1, wherein internal threads of the bottle body are screwed with external threads of the bottle cap, and the sealing ring is located above the external threads.

4. The medicine bottle of claim 1, wherein the boss is cylindrical, a through hole runs through the boss along its radial direction, and the hanging ring runs through the through hole.

5. The medicine bottle of claim 1, wherein both the bottle cap and the bottle body are made of metal materials, and a bottom of the bottle body is convex and arranged in an arc shape.

6. The medicine bottle of claim 1, wherein the telescopic rod is movably inserted into the fixed rod, and the fixed rod, the telescopic rod and the telescopic spoon are all made of metal materials.
